(19) United States
(12) Patent Application Publication
(10) Pub. No.: US 2020/0167655 A1
(43) Pub. Date: May 28, 2020

(54) METHOD AND APPARATUS FOR RE-CONFIGURING NEURAL NETWORK

(71) Applicant: Electronics and Telecommunications Research Institute, Daejeon (KR)

(72) Inventor: Jun Yong PARK, Daejeon (KR)

(73) Assignee: Electronics and Telecommunications Research Institute, Daejeon (KR)

(21) Appl. No.: 16/697,646

(22) Filed: Nov. 27, 2019

(30) Foreign Application Priority Data
Nov. 28, 2018 (KR) 10-2018-0150161
Oct. 18, 2019 (KR) 10-2019-0130043

(51) Int. Cl. G06N 3/08; G06N 3/04; G06N 3/10

(52) U.S. Cl. CPC G06N 3/082; G06N 3/10; G06N 3/04

(57) ABSTRACT

Disclosed are a method and apparatus for generating an ultra-light binary neural network which may be used by an edge device, such as a mobile terminal. A method of re-configuring a neural network includes obtaining a neural network model on which training for inference has been completed, generating a neural network model having a structure identical with the neural network model on which the training has been completed, performing sequential binarization on an input layer and filter of the generated neural network model for each layer, and storing the binarized neural network model. The method may further include providing the binarized neural network model to a mobile terminal.

### CLAIM FOR PRIORITY

This application claims priority to Korean Patent Applications No. 10-2018-0150161 filed on Nov. 28, 2018 and No. 10-2019-0130043 filed on Oct. 18, 2019, the entire contents of which are hereby incorporated by reference.

### BACKGROUND

### 1. Technical Field

The present disclosure relates to a method and apparatus for re-configuring a neural network, and more particularly, to a method and apparatus for generating an ultra-light binary neural network which may be used by a mobile terminal.

### 2. Related Art

In a super-connection data analysis environment, local real-time handling in addition to a reduction in network traffic gradually becomes important. The transmission of data on a cloud is reduced for various reasons (e.g., personal information, a network load, and the protection of company information), and the importance of edge analysis is increased.

The existing analysis scheme used on a cloud has many limits by nature in applying the analysis scheme to such edge analysis without any change. As performance of a current mobile device is improved and deep learning demands are increased, however, it is expected that deep learning will be generalized even in the mobile in the future. In particular, with the advent of the Internet of Things, a technology capable of managing the majority of smart things and actively performing deep learning analysis on data is in the spotlight.

In such an environment, there are proposed schemes, such as a lighting scheme for compressing, cutting or abbreviating the weight of the existing model for effective deep learning analysis in an edge or a limited space and a light-weight neural network having a light structure from the beginning. There is a binary neural network as a kind of representative light-weight neural network. A common neural network has an advantage in that a calculation speed is increased by about 60% or more compared to the existing neural network, but has a disadvantage in that the accuracy of a neural network is reduced by about 15% due to a lot of information loss.

### SUMMARY

Various embodiments are directed to the provision of a neural network re-configuration method for re-configuring a convolutional neural network into an ultra-light binary neural network.

Various embodiments are directed to the provision of an apparatus for re-configuring a neural network using the neural network re-configuration method.

In order to achieve the objective of the present disclosure, a method of re-configuring a neural network, the method may comprise obtaining a neural network model on which training for inference has been completed; generating a neural network model having a structure identical with the neural network model on which the training has been completed; performing sequential binarization on an input layer and filter of the generated neural network model for each layer; and storing the binarized neural network model.

Here, performing the sequential binarization for each layer may comprise performing binary threshold input separation on an input of a convolutional layer.

Performing the sequential binarization for each layer may comprise binarizing a filter of the convolutional layer.

Performing the binary threshold input separation on the input of the convolutional layer may comprise configuring a plurality of channels by separating the input layer into a plurality of ranges; and performing binarization on each of the channels based on a threshold.

Performing the binary threshold input separation on the input of the convolutional layer may comprise generating an additional layer between an input layer of the convolutional layer and a convolution filter.

Performing the sequential binarization for each layer may comprise performing a mean versus binarization on each weight of a fully-connected layer included in the structure of the neural network model.

Binarizing the filter of the convolutional layer may comprise separating a high-dimensional filter, included in the convolutional layer, into a plurality of low-dimensional filters; and separating the low-dimensional filters into a plurality of binary filters.

The binary filter may be calculated based on a standard deviation and average value of all matrices indicative of the low-dimensional filter.

The binary filter may comprise at least one of a 1×2 filter and a 2×1 filter.

The method may further comprise providing the binarized neural network model to a mobile terminal.

In order to achieve the objective of the present disclosure, an apparatus for re-configuring a neural network, the apparatus may comprise a processor; and a memory configured to store at least one command executed through the processor, wherein the at least one command comprises: a command for enabling a neural network model on which training for inference has been completed to be obtained; a command for enabling a neural network model having a structure identical with the neural network model on which the training has been completed to be generated; a command for enabling sequential binarization on an input layer and filter of the generated neural network model to be performed for each layer; and a command for enabling the binarized neural network model to be stored.

The command for enabling the sequential binarization to be performed for each layer may comprise a command for enabling binary threshold input separation to be performed on an input of a convolutional layer.

The command for enabling the sequential binarization to be performed for each layer may comprise a command for enabling a filter of the convolutional layer to be binarized.

The command for enabling the binary threshold input separation to be performed on the input of the convolutional layer may comprise a command for enabling a plurality of channels to be configured by separating the input layer into a plurality of ranges; and a command for enabling binarization on each of the channels to be performed based on a threshold.

The command for enabling the binary threshold input separation to be performed on the input of the convolutional layer may comprise a command for enabling an additional layer to be generated between an input layer of the convolutional layer and a convolution filter.

The command for enabling the sequential binarization to be performed for each layer may comprise a command for enabling a mean versus binarization to be performed on each weight of a fully-connected layer included in the structure of the neural network model.

The command for enabling the filter of the convolutional layer to be binarized may comprise a command for enabling a high-dimensional filter, included in the convolutional layer, to be separated into a plurality of low-dimensional filters; and a command for enabling the low-dimensional filters to be separated into a plurality of binary filters.

The binary filter may be calculated based on a standard deviation and average value of all matrices indicative of the low-dimensional filter.

The binary filter may comprise at least one of a 1×2 filter and a 2×1 filter.

The at least one command may further comprise a command for enabling the binarized neural network model to be provided to a mobile terminal.

### BRIEF DESCRIPTION OF THE DRAWINGS

FIG. 1 is a conceptual diagram of an inference service by a common mobile-supported cloud.

FIG. 2 is a conceptual diagram illustrating a process of inferring a response to a user request in a mobile terminal according to an embodiment of the present disclosure.

FIG. 3 is a structural diagram of a convolutional neural network used in an inference model.

FIG. 4 is a diagram for illustrating a binarization algorithm used in a common binary neural network.

FIG. 5 is an operational flowchart of a method of binarizing an inference model according to an embodiment of the present disclosure.

FIG. 6 is an operational flowchart of a binary threshold input separation method using a range threshold according to an embodiment of the present disclosure.

FIG. 7a illustrates an example of results obtained by performing common binary threshold input separation on sample data. FIG. 7b illustrates an example of results obtained by performing binary threshold input separation on sample data using a range threshold according to an embodiment of the present disclosure.

FIG. 8 is an operational flowchart of a method of binarizing the filter of a convolutional layer according to an embodiment of the present disclosure.

FIG. 9 illustrates the results of a comparison between the operations of a common convolution and a convolution in a binarization-completed neural network.

FIG. 10 illustrates the separation algorithm of a high-dimensional filter performed in a filter binarization process according to an embodiment of the present disclosure.

FIG. 11 illustrates the binarization algorithm of a low-dimensional filter performed in a filter binarization process according to an embodiment of the present disclosure.

FIG. 12 is a block diagram of an apparatus for re-configuring a neural network according to an embodiment of the present disclosure.

### DETAILED DESCRIPTION

Example embodiments of the present invention are disclosed herein. However, specific structural and functional details disclosed herein are merely representative for purposes of describing example embodiments of the present invention, and example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It should also be noted that in some alternative implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved.

Hereinafter, exemplary embodiments of the present invention will be described in detail with reference to the accompanying drawings.

Embodiments of the present disclosure propose a scheme for improving the accuracy problem of the existing binary neural network in order to solve the problems in the conventional technology. By considering that data training is difficult in an edge device, there is proposed a module capable of downloading a neural network model that has high accuracy and that is trained on a cloud, generating a similar binary neural network from the neural network model, and directly developing the binary neural network in an edge device.

Such a scheme can supplement disadvantages when the existing binary neural network is used and can support an edge device capable of precisely analyzing data immediately while consuming a small amount of a memory on a mobile through model binarization.

Hereinafter, various examples of embodiments will be described in detail with reference to the accompanying drawings.

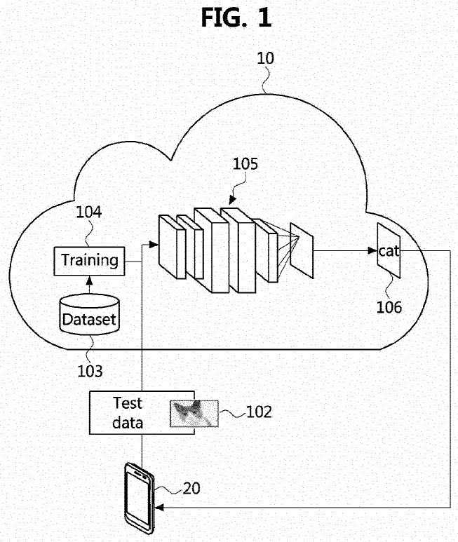

FIG. 1 is a conceptual diagram of an inference service by a common mobile-supported cloud.

The service illustrated in FIG. 1 is a form of a mobile-supported cloud service that is most commonly executed.

As the Internet is developed and a cloud computing technology emerges, test data 102 requested by a mobile terminal 20 is transmitted to a cloud server 10 as shown in FIG. 1.

In a usual case, the cloud server stores massive data (i.e., data set 103) in order to provide such a service. The cloud server performs inference on the data using a neural network trained through a training (104) process of learning information from the data set. That is, an artificial neural network (ANN) 105 is used to learn such massive data.

The trained ANN infers (106) the name, solution, result, correct answer, or label of the requested test data 102 when the test data 102 is input. The result inferred over the neural network through such a process may be transmitted from the cloud server to the mobile terminal.

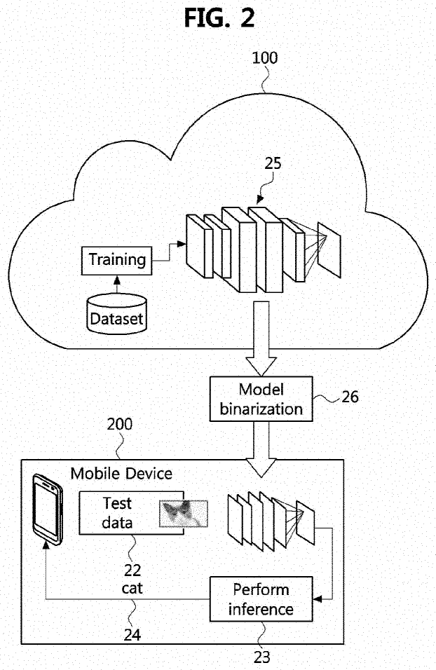

FIG. 2 is a conceptual diagram illustrating a process of inferring a response to a user request in a mobile terminal according to an embodiment of the present disclosure.

That is, FIG. 2 is a conceptual diagram illustrating an inference process performed by a terminal that has downloaded a light-weight model from a cloud. More specifically, the embodiment of the present disclosure illustrated in FIG. 2 illustrates a utilization example of deep learning in which a cloud compresses a model, previously trained using a data set, through binarization and transmits the compressed model to a mobile terminal and the mobile terminal infers a correct answer.

In this case, the terminal may denote a mobile terminal (MT), a mobile station (MS), an advanced mobile station (AMS), a high reliability mobile station (HR-MS), a subscriber station (SS), a portable subscriber station (PSS), an access terminal (AT) or a user equipment (UE), and may be a personal computer (PC), a notebook computer, a personal digital assistant (PDA), a portable multimedia player (PMP), a PlayStation Portable (PSP), a wireless communication terminal, a smartphone, or a server terminal, such as a TV application server or a service server.

Referring to FIG. 2, as in the common case of FIG. 1, a cloud server 100 fetches a data set and performs neural network training. However, the cloud server 100 performs binarization compression (26) on an inference model without receiving or inferring data requested by a mobile terminal 200, and transmits the inference model to the mobile terminal 200.

The binarization-compressed and transmitted model is executed by the mobile terminal 200. Test data 22 requested by a user through the mobile terminal 200 is inferred (23) within the mobile terminal.

To derive a correct answer 24 most similar to that of the cloud server through such mobile inference is an object of an embodiment of the present disclosure. In order to achieve the object, to compress a deep learning model obtained from a server so that the deep learning model can also be executed in a mobile terminal and to provide the compressed model to the mobile terminal are main technical elements according to embodiments of the present disclosure.

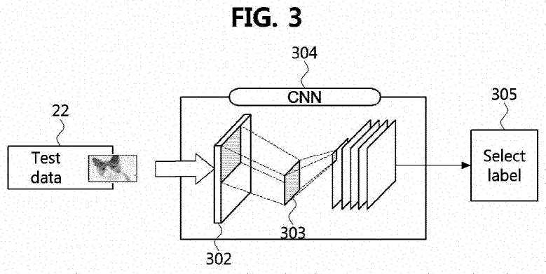

FIG. 3 is a structural diagram of a convolutional neural network used in an inference model.

A convolutional neural network (CNN) 304 illustrated in FIG. 3 is the inference model used in FIGS. 1 and 2 and is a frequently used neural network.

An artificial neural network (ANN) is a technology most commonly used in machine learning. Referring to FIG. 3, when test data 22 to be inferred is input to the ANN, the ANN is trained using a method of teaching a neuron the features of data based on multiple layers 302 configured with numerous neurons. The CNN 304 is one of the ANNs, and is used to more easily analyze data using a convolution of the input data 22 and a filter 303.

In this case, the ANN is a statistical training algorithm that is inspired by the neural network of biology (in particular, the brain of the central nervous system of an animal) in machine learning and cognitive science. The ANN generally refers to a model in which an artificial neuron (or node) that has formed a network through a combination of synapses has a problem-solving ability by changing the combined intensity of the synapses through training.

The ANN includes teacher learning that is optimized to a problem based on the input of a teacher signal (i.e., correct answer) and non-teacher learning that does not require a teacher signal. In general, teacher learning is used when a clear solution is present, and non-teacher learning is used for data clustering. The ANN is used when a function that depends on many inputs and that is commonly veiled is guessed and approximated. In general, the ANN is represented as an interconnection of neuron systems that calculate a value from an input, and may perform machine learning, such as pattern recognition, in adaptability.

The CNN is used in the field in which a large amount of visual information is used, and has high utilization because it has high inference accuracy although a large amount of data is trained. An embodiment of the present disclosure proposes a binary lighting method of a CNN in order to maintain a result for the inference (305) of such a convolution. Referring to FIG. 3, in general, an inference result of a CNN for input visual data, for example, an image may be a label related to the corresponding data or image. The filter 303 of such a CNN is mostly configured with real numbers.

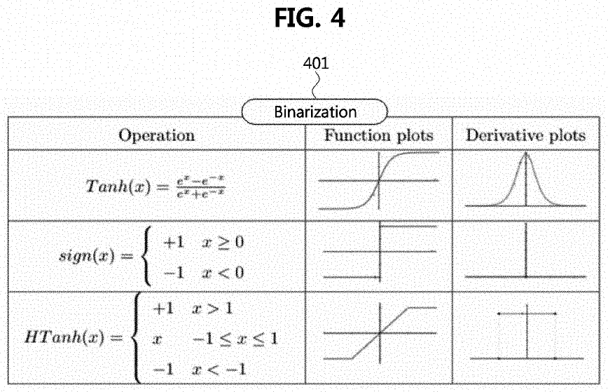

FIG. 4 is a diagram for illustrating a binarization algorithm used in a common binary neural network.

Referring to FIG. 4, binarization 401 may be understood as a process of simplifying data into (−1) or (+1). A hyperbolic tangent function (Tanh (x)), a sine function (Sign (x)), and HTanh (x) may be used for a binarization operation. FIG. 4 also illustrates a function plot and derivative plot for each function.

A binary neural network is a kind of light-weight neural network. The binary neural network is similar to the existing neural network, but is a network which enables a value, calculated by setting a weight value to (−1) or (+1), to be calculated very lightly and rapidly. In the binary neural network, a memory consumed to store the existing 32 bit float is reduced 32 times (32 bits->1 bit) and a calculation speed is also increased by about 60% because a value (−1) or (+1) is handled. However, the accuracy of a common binary neural network is reduced by about 15% because a lot of information loss occurs.

The majority of numerical values within a model used for the CNN are stored as 32 bit float values. Such a 32-bit float value consumes a lot of memory for storage and also has a heavy load in calculation. Such a problem still occurs although performance of a mobile terminal is improved. The reason for this is that the more the CNN technology is developed, the number of layers and the number of filters are increased. Binarization can contribute to model lighting by catching explosively increasing data as described above.

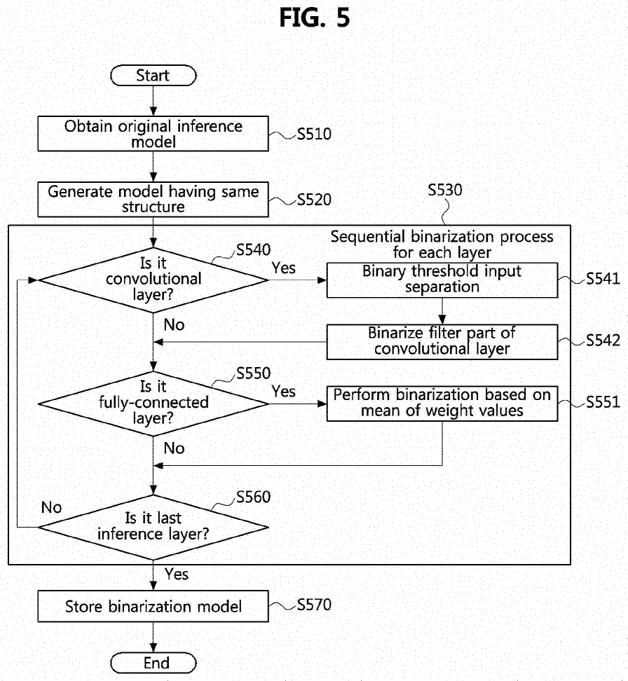

FIG. 5 is an operational flowchart of a method of binarizing an inference model according to an embodiment of the present disclosure.

The binarization method of FIG. 5 according to an embodiment of the present disclosure may be performed by a model binarization apparatus, for example, a user equipment, but the subject of an operation is not limited thereto. The model binarization apparatus can reduce the size of a model by binary-compressing an ANN configured with the existing 32 bit float values and thus increase the processing speed of the ANN.

First, the model binarization apparatus reads the original inference model having the existing size by obtaining the model, which has not been processed, from a cloud server (S510), and generates a model having the same structure from the original inference model (S520). That is, the model binarization apparatus copies information on the layer, filter or bias of the original inference model by reading the corresponding model.

Thereafter, the model binarization apparatus performs a process of sequentially binarizing each of layers starting from an input layer of the generated model (S530).

In the sequential binarization process for each layer (S530), whether a corresponding layer is a convolutional layer is checked (S540). If the corresponding layer is a convolutional layer, the model binarization apparatus performs binary threshold input separation, using a range threshold, on the input part of the convolutional layer (S541), and also binarizes the filter part of the convolutional layer (S542).

If the corresponding layer is a fully-connected layer (Yes in S550), the model binarization apparatus simply performs binarization based on the mean of weight values through weight binarization (S551). If the corresponding layer is a layer that is inferred last (S560), the model binarization apparatus stores the entire model on which binarization has been completed without binarizing a corresponding part (S570). It is expected that an algorithm according to the method of FIG. 5 will be compatible with most of simple CNNs.

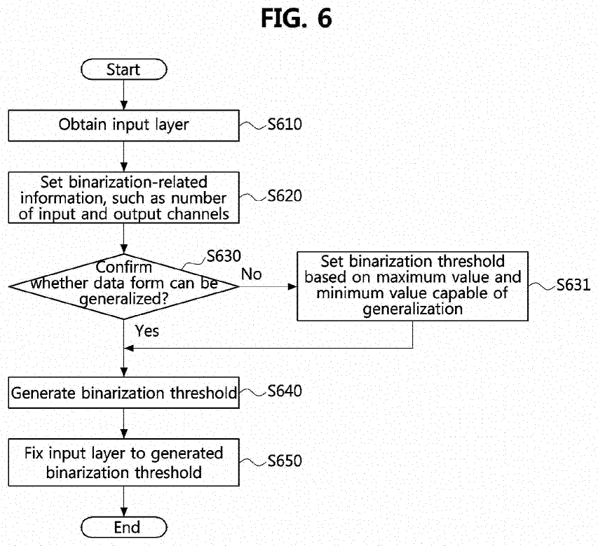

FIG. 6 is an operational flowchart of a binary threshold input separation method using a range threshold according to an embodiment of the present disclosure.

The binary threshold input separation method according to an embodiment of the present disclosure may be performed by a model binarization apparatus, for example, a user equipment, but the subject of an operation is not limited thereto.

In the embodiment illustrated in FIG. 6, the binary threshold input separation process (S541) described with reference to FIG. 5 is described more specifically.

In the present embodiment, the sign( ) function described with reference to FIG. 4 is basically used as a binarization algorithm. The sign( ) function has a form of −1 when it is smaller than 0, and has a form of +1 when it is greater than 0. Most of binary neural networks inevitably have a limited data form because they binarize the data using such a sign( ) function.

Accordingly, an embodiment of the present disclosure adopts a method of distributing and positioning a threshold for dividing −1 and +1 and differently setting a binarization criterion applied to a specific input value in order to diversify information and not to sacrifice a data compression ratio.

The model binarization apparatus obtains the input layer of a convolutional layer, that is, the subject of binarization (S610). The model binarization apparatus generates an additional layer that separates data into (−1) and (+1) using a threshold between such a convolution input layer and a convolution filter.

The model binarization apparatus sets binarization-related information for the obtained convolution input layer (S620). The binarization-related information may include hyper parameters, such as the number of output channels, a range of a threshold to be designated, and a distribution of a range threshold to be designated (e.g., a normal distribution or a uniform distribution).

When the binarization-related information is set, the model binarization apparatus confirms whether a data form of the input layer can be generalized into (−1) and (+1) (S630). If the data form of the input layer can be generalized into (−1) and (+1), the model binarization apparatus generates a binarization threshold by distributing the threshold in the range of −1 to 1 based on the number of channels of the input layer (S640). If the data form of the input layer cannot be generalized, the model binarization apparatus determines and distributes the range of the threshold based on a maximum value and minimum value where the data can be generalized (S631). When a distribution of binary thresholds is generated as described above, the binary thresholds appear to have a form of a single layer. The model binarization apparatus generates such threshold channels based on the number of output channels, and fixes the input layer of a convolution so that a value of (+1) and a value of (−1) can be output to the outside of a module if the input of the module is greater than the threshold of a corresponding channel and if the input of the module is smaller than the threshold of the corresponding channel, respectively (S650).

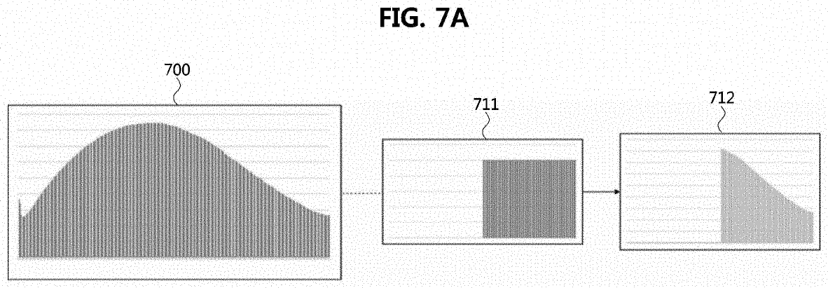

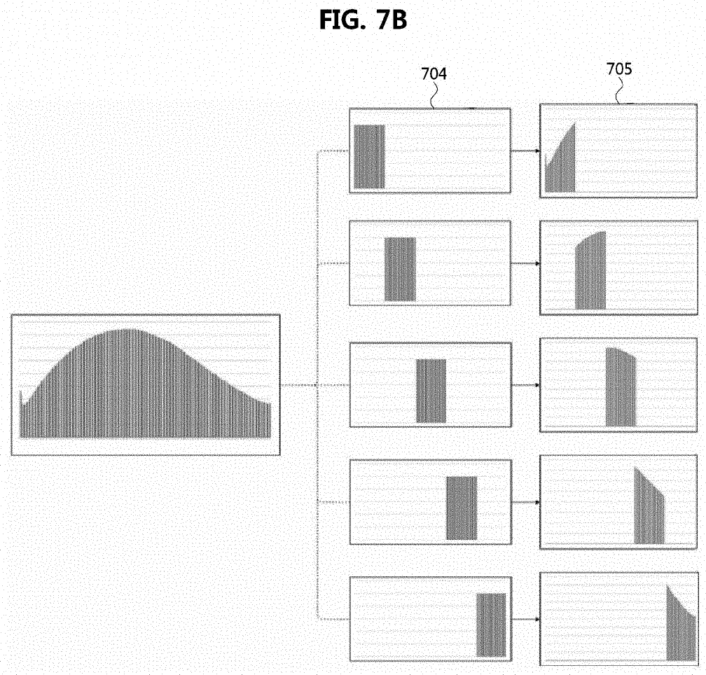

FIG. 7a illustrates an example of results obtained by performing common binary threshold input separation on sample data. FIG. 7b illustrates an example of results obtained by performing binary threshold input separation on sample data using a range threshold according to an embodiment of the present disclosure.

FIG. 7a illustrates a form commonly taken by an existing RGB image data 700. The majority of RGB values generated in nature follow a normal distribution of curves. As described with reference to FIG. 4, in basic binarization, a data distribution is divided into two by simply dividing data into −1 and +1. The reason for this is that a common binarization algorithm 711 divides data by considering only the mean as a threshold.

In contrast, in an embodiment of the present disclosure, binarization is performed by dividing data into several ranges using a filter 704 of FIG. 7b without considering a range threshold as the mean 0. That is, binarization according to an embodiment of the present disclosure is performed by dividing data more specifically compared to a common binarization method. That is, the embodiment of FIG. 7b illustrates a construction in which the filter 704 having a specific range is attached to the convolutional input layer of FIG. 6 so that the input image data 700 is divided like result data 705.

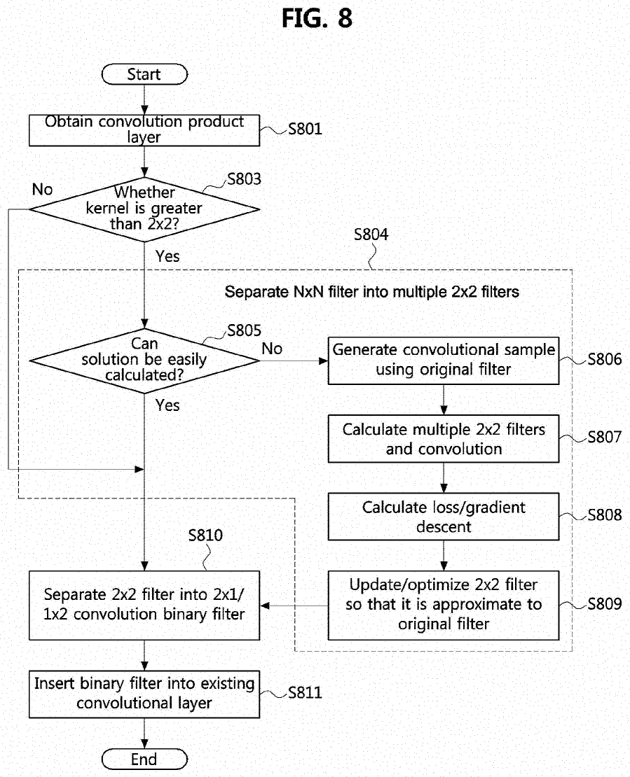

FIG. 8 is an operational flowchart of a method of binarizing the filter of a convolutional layer according to an embodiment of the present disclosure.

FIG. 8 is a flowchart illustrating a process of performing binarization on the filter of a convolutional layer according to an embodiment of the present disclosure. The filter binarization method of a convolutional layer according to an embodiment of the present disclosure may be performed by an inference model binarization apparatus, for example, a user equipment, but the subject of an operation is not limited thereto.

The inference model binarization apparatus reads a convolutional layer and analyzes the filter of the convolutional layer (S801). More specifically, the inference model binarization apparatus determines whether the kernel of the convolutional layer, that is, the size of a two-dimensional filter is greater than 2×2 (S803). First, a procedure for setting the filter as a 2×2 form is performed in order to perform smooth binarization suitable for an edge device. After whether a filter having a large size can be converted into a filter of a small unit is determined (S803), a procedure of separating an N×N filter into multiple 2×2 filters is performed (S804).

The inference model binarization apparatus determines whether a real number value satisfying the condition of the 2×2 filter is present, that is, whether a solution for filter separation can be easily calculated (S805). If the solution can be easily calculated, the inference model binarization apparatus separates the 2×2 filter into several 2×2 filters (S810). If a real number value satisfying the condition of the 2×2 filter is not present, that is, if the solution is not easily calculated, the inference model binarization apparatus generates a convolutional sample using an actual value of the original filter (S806), and calculates a convolution with the multiple 2×2 filters randomly initialized with respect to the generated convolutional sample (S807).

Thereafter, the inference model binarization apparatus calculates the original filter versus a loss according to Equation 1, finds a value approximate to the original filter using a gradient descent (S808), and optimizes the 2×2 filter (S809).

F(W)=|L1_Norm(X⊗W_{(n,n)})−L1_Norm((X⊗W′_{n-1,n-1})⊗W′_{n-1,n-1})|² [Equation 1]

Finally, the inference model binarization apparatus separates the 2×2 filter into [2×1][1×2] matrices by separating the 2×2 filter in a binary row and column (S810), and inserts the generated multiple binary [2×1][1×2] filters into the existing convolutional layer (S811).

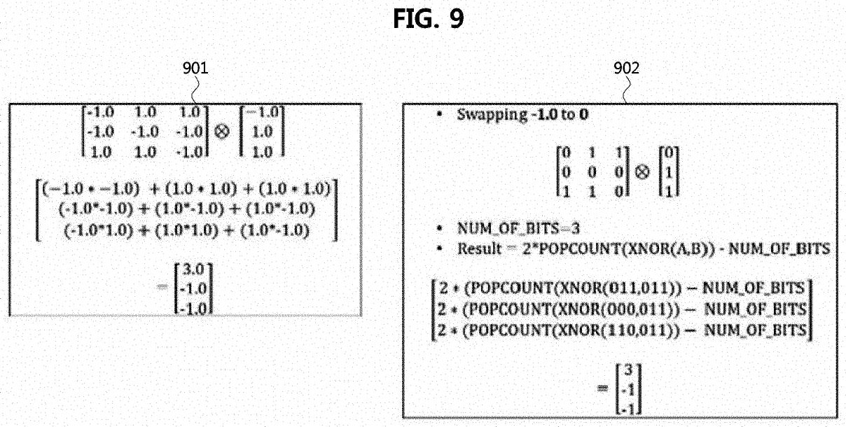

FIG. 9 illustrates the results of a comparison between the operations of a common convolution and a convolution in a binarization-completed neural network.

Referring to FIG. 9, a block 901 illustrates the results of a convolution based on common float values. A block 902 illustrates the results of a convolution based on binarization-completed values.

In the existing matrix illustrated in the block 901, a float (1.0) and a float (−1.0) are stored as values of 32 bits. In the block 901 according to the existing method, an operation is performed in such a manner that each value is multiplied and added while the value moves each filter with respect to an input.

In contrast, inputs and filters illustrated in the block 902 are all in the binarized state. Accordingly, in the block 902, a convolution operation is performed not using multiplication and addition but using a logic gate XNOR and a bit operation POPCOUNT and may have a faster calculation speed than the operation performed in the block 901.

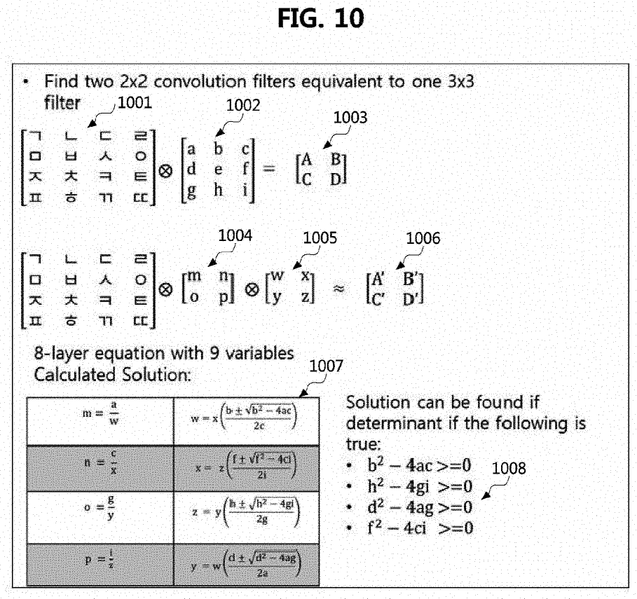

FIG. 10 illustrates the separation algorithm of a high-dimensional filter performed in a filter binarization process according to an embodiment of the present disclosure.

FIG. 10 is an embodiment of a method of separating a high-dimensional filter into multiple binary filters according to an embodiment of the present disclosure, and illustrates a case where a 3×3 high-dimensional filter is separated into two 2×2 filters.

From FIG. 10, it may be seen that if data 1001 is input to a convolutional layer including a high-dimensional filter, a result using a 3×3 filter 1002 is a 2×2 output value 1003.

A result table 1007 is obtained by performing calculation so that the same result 1006 as that when the existing 3×3 filter is used is obtained through a multi-convolution with the input data using two 2×2 filters 1004 and 1005 similar to the role of the 3×3 filter 1002 instead of the 3×3 filter 1002.

First, a convolution of the input value 1001 and the first filter 1004 is performed. The result 1006 derived by performing a convolution of the result of the corresponding convolution and the second filter 1005 is compared with the convolutional value 1003 of the high-dimensional filter. Accordingly, from the result table 1007, it may be seen that the values of the two 2×2 filters are mechanically calculated based on the values of the existing 3×3 filter.

In this case, in the process of calculating the values, real number values can be obtained only when all of four conditional sentences 1008 are satisfied. If any one of the four conditional sentences is not satisfied, it is impossible to calculate the values of the two 2×2 filters using a mechanical calculation method based on the calculation equation 1007. In this case, a method of finding proximate values using a gradient descent may be used.

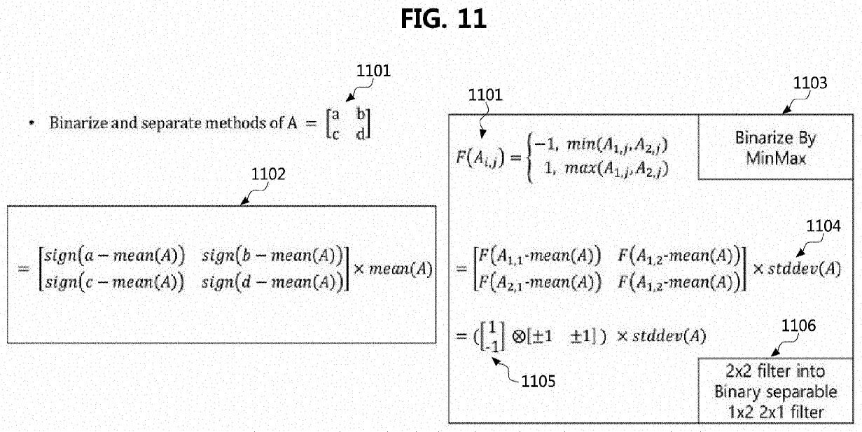

FIG. 11 illustrates the binarization algorithm of a low-dimensional filter performed in a filter binarization process according to an embodiment of the present disclosure.

FIG. 11 illustrates an algorithm for performing binarization and 2×1 1×2 separation on a 2×2 filter, that is, an example of a low-dimensional filter. That is, FIG. 11 illustrates an example in which a low-dimensional 2×2 filter according to an embodiment of the present disclosure is changed into a lower-dimensional 2×1, 1×2 filter.

Referring to FIG. 11, if a 2×2 real number matrix 1101 is given, a method 1102 of calculating the mean and extracting a sign is used in the existing binary neural network. This method may be advantageously used when filters are generally and identically integrated.

In contrast, a method proposed by an embodiment of the present disclosure is a method in which a mean squared error rate with the original filter is about 10% smaller than that of the existing method when a filter is recombined (i.e., returned to its original state). The method according to an embodiment of the present disclosure is also useful for filter separation using a 2×1, 1×2 method.

In the filter binarization method according to an embodiment of the present disclosure, a filter is divided into (−1) and (+1) in a column unit using a numerical value identification function 1101 per column. In this case, (−1) and (+1) are uniformly distributed to columns (1103). A constant value and a bias are positioned at the end part of an equation so that the filter returns to its original state using a standard deviation (stddev(A)) 1104 and the mean value (mean(A)) of all matrices. The matrix configured with (−1) and (+1) can be separated into lower ranks because it is spatially separable (1106).

If the embodiments of the present disclosure described through the above-described embodiments, in particular, the binary input illustrated in FIG. 4 and multiple binary filters derived through the binarization algorithm of FIG. 11 are used, data can be analyzed more rapidly in an edge environment in which serial calculation is faster than parallel calculation. Furthermore, inference accuracy is improved because a loss of information is reduced compared to the existing binary neural network.

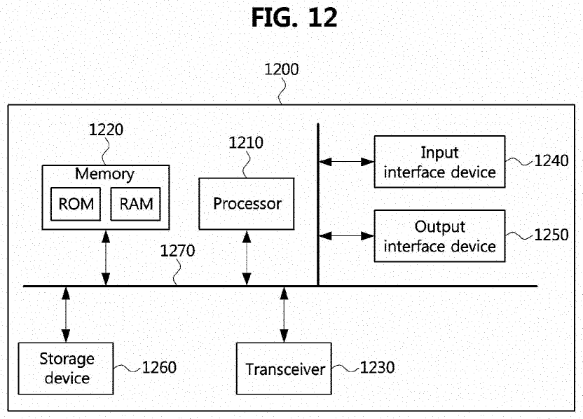

FIG. 12 is a block diagram of an apparatus 1200 for re-configuring a neural network according to an embodiment of the present disclosure.

The apparatus 1200 for re-configuring a neural network according to an embodiment of the present disclosure may include at least one processor 1210, a memory 1220 configured to store at least one command executed through the processor, and a transceiver 1230 connected to a network and configured to perform communication.

The apparatus 1200 for re-configuring a neural network may further include an input interface device 1240, an output interface device 1250, and a storage device 1260. The elements included in the apparatus 1200 for re-configuring a neural network may be connected by a bus 1270 and may perform communication with each other.

The processor 1210 may execute a program command stored in at least one of the memory 1220 and the storage device 1260. The processor 1210 may mean a central processing unit (CPU), a graphics processing unit (GPU), or a dedicated processor in which the methods according to the embodiments of the present disclosure are performed. Each of the memory 1220 and the storage device 1260 may be configured with at least one of a volatile storage medium and a non-volatile storage medium. For example, the memory 1220 may be configured with at least one of a read only memory (ROM) and a random access memory (RAM).

In this case, the at least one command may include a command for enabling the processor to obtain a neural network model on which training for inference has been completed, a command for enabling the processor to generate a neural network model having the same structure as the neural network model on which the training has been completed, a command for enabling the processor to perform sequential binarization on the input layer and filter of the generated neural network model for each layer, and a command for enabling the processor to store the binarized neural network model.

The command for enabling the processor to perform sequential binarization for each layer may include a command for enabling the processor to perform binary threshold input separation on the input of the convolutional layer and a command for enabling the processor to binarize a filter of the convolutional layer.

The command for enabling the processor to perform sequential binarization for each layer may further include a command for enabling the processor to perform the mean versus binarization on each weight of a fully-connected layer included in the structure of the neural network model.

The command for enabling the processor to perform the binary threshold input separation on the input of the convolutional layer may include a command for enabling the processor to configure a plurality of channels by separating the input layer into a plurality of ranges, and a command for enabling the processor to perform binarization on each of the channels based on a threshold. The command for enabling the processor to perform the binary threshold input separation on the input of the convolutional layer includes generating an additional layer between the input layer of the convolutional layer and a convolution filter.

The command for enabling the processor to binarize the filter of the convolutional layer may include a command for enabling the processor to separate a high-dimensional filter, included in the convolutional layer, into a plurality of low-dimensional filters, and a command for enabling the processor to separate the low-dimensional filters into a plurality of binary filters.

The binary filter may be calculated based on a standard deviation and average value of all matrices indicative of the low-dimensional filter, and may include at least one of a 1×2 filter and a 2×1 filter.

The at least one command may further include a command for enabling the processor to provide the binarized neural network model to a mobile terminal.

In accordance with the embodiments of the present disclosure, a deep learning model generated in a server or a cloud can be generated as a binarized model by reducing a loss of accuracy and through compression. The binarized model can be converted into a filter suitable for serial computing used in an edge/mobile environment. The filter can be transmitted to a mobile device so that the mobile device can directly execute data inference.

Accordingly, an artificial intelligence (AI) tool can be ubiquitously used using a mobile terminal, etc. although the mobile terminal is not connected to the Internet or a cloud server or data is not transmitted.

The embodiments of the present disclosure may be implemented as program instructions executable by a variety of computers and recorded on a computer readable medium. The computer readable medium may include a program instruction, a data file, a data structure, or a combination thereof. The program instructions recorded on the computer readable medium may be designed and configured specifically for the present disclosure or can be publicly known and available to those who are skilled in the field of computer software.

Examples of the computer readable medium may include a hardware device such as ROM, RAM, and flash memory, which are specifically configured to store and execute the program instructions. Examples of the program instructions include machine codes made by, for example, a compiler, as well as high-level language codes executable by a computer, using an interpreter. The above exemplary hardware device can be configured to operate as at least one software module in order to perform the embodiments of the present disclosure, and vice versa.

While various embodiments have been described above, it will be understood to those skilled in the art that the embodiments described are by way of example only. Accordingly, the disclosure described herein should not be limited based on the described embodiments.

What is claimed is:

1. A method of re-configuring a neural network, the method comprising:
obtaining a neural network model on which training for inference has been completed;
generating a neural network model having a structure identical with the neural network model on which the training has been completed;
performing sequential binarization on an input layer and filter of the generated neural network model for each layer; and
storing the binarized neural network model.

2. The method of claim 1, wherein performing the sequential binarization for each layer comprises performing binary threshold input separation on an input of a convolutional layer.

3. The method of claim 1, wherein performing the sequential binarization for each layer comprises binarizing a filter of the convolutional layer.

4. The method of claim 2, wherein performing the binary threshold input separation on the input of the convolutional layer comprises:
configuring a plurality of channels by separating the input layer into a plurality of ranges; and
performing binarization on each of the channels based on a threshold.

5. The method of claim 1, wherein performing the binary threshold input separation on the input of the convolutional layer comprises generating an additional layer between an input layer of the convolutional layer and a convolution filter.

6. The method of claim 1, wherein performing the sequential binarization for each layer comprises performing a mean versus binarization on each weight of a fully-connected layer included in the structure of the neural network model.

7. The method of claim 3, wherein binarizing the filter of the convolutional layer comprises:
separating a high-dimensional filter, included in the convolutional layer, into a plurality of low-dimensional filters; and
separating the low-dimensional filters into a plurality of binary filters.

8. The method of claim 7, wherein the binary filter is calculated based on a standard deviation and average value of all matrices indicative of the low-dimensional filter.

9. The method of claim 7, wherein the binary filter comprises at least one of a 1×2 filter and a 2×1 filter.

10. The method of claim 1, further comprising providing the binarized neural network model to a mobile terminal.

11. An apparatus for re-configuring a neural network, the apparatus comprising:
a processor; and
a memory configured to store at least one command executed through the processor,
wherein the at least one command comprises:
a command for enabling a neural network model on which training for inference has been completed to be obtained;
a command for enabling a neural network model having a structure identical with the neural network model on which the training has been completed to be generated;
a command for enabling sequential binarization on an input layer and filter of the generated neural network model to be performed for each layer; and
a command for enabling the binarized neural network model to be stored.

12. The apparatus of claim 11, wherein the command for enabling the sequential binarization to be performed for each layer comprises a command for enabling binary threshold input separation to be performed on an input of a convolutional layer.

13. The apparatus of claim 11, wherein the command for enabling the sequential binarization to be performed for each layer comprises a command for enabling a filter of the convolutional layer to be binarized.

14. The apparatus of claim 11, wherein the command for enabling the binary threshold input separation to be performed on the input of the convolutional layer comprises:
a command for enabling a plurality of channels to be configured by separating the input layer into a plurality of ranges; and
a command for enabling binarization on each of the channels to be performed based on a threshold.

15. The apparatus of claim 11, wherein the command for enabling the binary threshold input separation to be performed on the input of the convolutional layer comprises a command for enabling an additional layer to be generated between an input layer of the convolutional layer and a convolution filter.

16. The apparatus of claim 11, wherein the command for enabling the sequential binarization to be performed for each layer comprises a command for enabling a mean versus binarization to be performed on each weight of a fully-connected layer included in the structure of the neural network model.

17. The apparatus of claim 13, wherein the command for enabling the filter of the convolutional layer to be binarized comprises:
a command for enabling a high-dimensional filter, included in the convolutional layer, to be separated into a plurality of low-dimensional filters; and
a command for enabling the low-dimensional filters to be separated into a plurality of binary filters.

18. The apparatus of claim 17, wherein the binary filter is calculated based on a standard deviation and average value of all matrices indicative of the low-dimensional filter.

19. The apparatus of claim 17, wherein the binary filter comprises at least one of a 1×2 filter and a 2×1 filter.

20. The apparatus of claim 11, wherein the at least one command further comprises a command for enabling the binarized neural network model to be provided to a mobile terminal.
